(19) United States
(12) Patent Application Publication
(10) Pub. No.: US 2025/0384292 A1
(43) Pub. Date: Dec. 18, 2025

(54) DETECTION AND MITIGATION OF HAZARDS IN MACHINE LEARNING FOUNDATION MODELS

(71) Applicant: International Business Machines Corporation, Armonk, NY (US)

(72) Inventors: Jeremy R. Fox, Georgetown, TX (US); Krishna Manish Sheth, Lowell, MA (US); Andrew T. Penrose, Castleknock (IE); Jonathan D. Dunne, Dungarvan (IE)

(21) Appl. No.: 18/746,244

(22) Filed: Jun. 18, 2024

(51) Int. Cl. G06N 3/094

(52) U.S. Cl. CPC G06N 3/094

(57) ABSTRACT

An embodiment of the present invention includes a system for detecting and mitigating vulnerabilities in machine learning models. The system produces, via a machine learning model, responses to input data. The input data includes data that causes the machine learning model to produce proper and improper responses. Information associated with the input data and responses is maintained. The information includes timing information for the responses. A probability for a time to an improper response for the machine learning model is determined based on the maintained information. A hazard level for the machine learning model is identified based on the probability for the time to an improper response. Embodiments of the present invention further include a method and computer program product for detecting and mitigating vulnerabilities for machine learning models in substantially the same manner described above.

### BACKGROUND

### 1. Technical Field

Present invention embodiments relate to security for machine learning models, and more specifically, to identifying potential hazards in machine learning foundation models that are used to update the machine learning foundation models and substantially reduce the likelihood of adversarial attacks.

### 2. Discussion of the Related Art

Foundation models are typically large-scale machine learning models that are trained on massive datasets of unlabeled data (e.g., Large Language Models (LLM), etc.). These models are capable of learning general representations of the world that can be adapted to a wide range of downstream tasks. However, foundation models are also susceptible to adversarial attacks, where malicious actors intentionally manipulate input to cause unexpected or harmful behavior. Adversarial attacks are carefully crafted inputs that are designed to fool machine learning models. For example, an attacker can change a sentiment of a sentence by adding “not” or “can't” words, or an attacker can add patches to images of letters or symbols that can make it look like something very different. Thus, adversarial attacks can have a significant impact on the performance of foundation models. In addition, comprehension is an issue that can blight the output of foundation models due, in part to, a general lack of comprehension by the model.

Ensuring foundation model comprehension, robustness, and safety is an ongoing area of research. However, the research focuses on indicating issues with foundation models with respect to Comprehensive Ranking System (CRS) scores, and providing ways to measure comprehension, robustness, and safety metrics as a form of an aggregated scoring mechanism (e.g., AdvGLUE and ANLI).

### SUMMARY

According to one embodiment of the present invention, a system for detecting and mitigating vulnerabilities in machine learning models comprises one or more memories and a processor coupled to the one or more memories. The system produces, via a machine learning model, responses to input data. The input data includes data that causes the machine learning model to produce proper and improper responses. Information associated with the input data and responses is maintained. The information includes timing information for the responses. A probability for a time to an improper response for the machine learning model is determined based on the maintained information. A hazard level for the machine learning model is identified based on the probability for the time to an improper response. Embodiments of the present invention further include a method and computer program product for detecting and mitigating vulnerabilities for machine learning models in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a procedural flowchart of a manner to evaluate and update a foundation model according to an embodiment of the present invention.

FIG. 3 is a flow diagram of training foundation models according to an embodiment of the present invention.

FIG. 4 is a flow diagram of analyzing a foundation model according to an embodiment of the present invention.

FIG. 5 is a flow diagram of generating a comprehension robustness map for foundation models according to an embodiment of the present invention.

FIG. 6 is an illustration of an example Kaplan-Meier plot that is used to determine a probability of a time to an improper response for a foundation model according to an embodiment of the present invention.

FIG. 7 is a flow diagram of determining a hazard level according to an embodiment of the present invention.

FIG. 8 is an illustration of example output of an analysis of foundation models according to an embodiment of the present invention.

### DETAILED DESCRIPTION

Foundation models are typically large-scale machine learning models that are trained on massive datasets of unlabeled data (e.g., Large Language Models (LLM), etc.). These models are capable of learning general representations of the world that can be adapted to a wide range of downstream tasks. However, foundation models are also susceptible to adversarial attacks. Adversarial attacks are carefully crafted inputs that are designed to fool machine learning models. For example, an attacker can change a sentiment of a sentence by adding “not” or “can't” words, or an attacker can add patches to images of letters or symbols that can make it look like something very different. Thus, adversarial attacks can have a significant impact on the performance of foundation models.

Accordingly, an embodiment of the present invention preserves integrity of foundation models and avoids the impact of adversarial attacks at a very early stage of model development. The embodiment categorizes foundation models using survival analysis, and identifies potential hazards in foundation models that can be used to update the foundation models and substantially reduce the likelihood of adversarial attacks. The survival analysis identifies fine-tuning training data (e.g., documents, etc.) and/or prompts (e.g., inquiries, etc.) that facilitate an improper response (or hazard) from foundation models.

An embodiment of the present invention combines a statistical area of survival analysis with the identification of when fine-tuning or prompt data could be having an adverse effect in the usage of foundation models. The embodiment fine-tunes foundation models given a set of clean datasets and a set of appropriate prompt inputs. A comprehension robustness map is generated from the fine-tuned models based on attack datasets, attack inputs, and normal inputs. A hazard level model uses hazard ratios from a hazard ratio datastore and the comprehensive robustness map to calculate a time-to-event probability of a negative output (or improper response) from a foundation model (e.g., due to an adversarial attack, etc.). The hazard level model can be used to generalize across different domains, thereby building a set of foundation models that can be classified based on their hazard level in terms of use in that domain.

An embodiment of the present invention dynamically evaluates and mitigates potential hazards tied to the use of new or existing foundation models when deployed in creating fine- tuned models across various domains. The embodiment identifies adversarial attacks, comprehends data, and ensures model robustness, thereby fostering safety and accurate performance.

An embodiment of the present invention employs a statistical approach that combines hazard ratios with identifying when fine-tuning or prompt data may be generating a detrimental effect in the usage of foundation models. The embodiment leverages these aspects to compute the time-to-event probability of foundation models producing an adverse output (or improper response) from adversarial attacks or any other negative influence. A comprehension robustness map of the embodiment utilizes metadata from the output and prompt datasets of the foundation models to feed into a hazard level model. The output is comprehensively analyzed and used by the hazard level model that indicates the probable occurrence of adverse behavior of foundational models based on a calculated hazard ratio. The hazard level model of the embodiment uses the calculated hazard probabilities and the output over time to classify and categorize foundation models based on their hazard levels within particular domains. The embodiment leverages these classifications to indicate optimal foundation models for use within specific domains, thereby reducing potential hazards.

According to an aspect of the invention, there is provided a method of detecting and mitigating vulnerabilities in machine learning models. The method comprises producing, via a machine learning model of a processor, responses to input data. The input data includes data that causes the machine learning model to produce proper and improper responses. The processor maintains information associated with the input data and responses. The information includes timing information for the responses. The processor determines a probability for a time to an improper response for the machine learning model based on the maintained information. The processor identifies a hazard level for the machine learning model based on the probability for the time to an improper response. This provides security for machine learning models to avoid attacks. In addition, the analysis enables selection of the best (or most secure) machine learning models to use or employ for a domain, thereby improving accuracy and performance.

In embodiments, the machine learning model is configured for a specific domain. This enables use of various machine learning models specific to corresponding domains to improve accuracy and performance.

In embodiments, the machine learning model is pre-trained, and the responses are produced during additional training to fine-tune the machine learning model for the domain. This enables the machine learning model to be analyzed during fine-tuning to be continuously updated (or re-trained) based on the analysis (e.g., indicating datasets, prompts, etc. causing the improper responses or vulnerabilities) to improve model security, reduce failures (or improper responses), and increase times (or amount of inputs) between failures.

In embodiments, the machine learning model includes a large language model. This enables a large language model to be analyzed and updated for mitigating vulnerabilities and improving accuracy and performance.

In embodiments, the input data includes clean data and clean prompts that cause the machine learning model to produce a proper response, and attack data and attack prompts that cause the machine learning model to produce an improper response. This enables a thorough evaluation of the machine learning model based on various datasets to enable updates for mitigating vulnerabilities and improving accuracy and performance.

In embodiments, the responses are produced for a first trial including the clean data and clean prompts and a second trial including the attack data and attack prompts, and determining the probability for the time to an improper response comprises determining the probability for the time to an improper response for the machine learning model based on probabilities for the time to an improper response determined for the first and second trials. This enables the machine learning model to be analyzed against different datasets in separate trials to evaluate the machine learning model for vulnerabilities under different conditions, thereby enabling updating of the machine learning model for mitigating vulnerabilities and improving accuracy and performance.

In embodiments, the processor identifies the input data causing the improper responses, and modifies a training set for the machine learning model to compensate for the identified input data. The processor re-trains the machine learning model with the modified training set to mitigate the improper responses. This enables the machine learning model to be analyzed and continuously updated (or re-trained) based on the analysis (e.g., indicating datasets, prompts, etc. causing the improper responses or vulnerabilities) to improve model security, reduce failures (or improper responses), and increase times (or amount of inputs) between failures. Further, embodiments may identify specific models and/or data causing improper responses and specifically modify training sets and training of the specific models, thereby avoiding training of all models for a domain.

According to an aspect of the invention, a system for detecting and mitigating vulnerabilities in machine learning models comprises one or more memories and a processor coupled to the one or more memories. The processor, via a machine learning model, produces responses to input data. The input data includes data that causes the machine learning model to produce proper and improper responses. The processor maintains information associated with the input data and responses. The information includes timing information for the responses. The processor determines a probability for a time to an improper response for the machine learning model based on the maintained information. The processor identifies a hazard level for the machine learning model based on the probability for the time to an improper response. This provides security for machine learning models to avoid attacks. In addition, the analysis enables selection of the best (or most secure) machine learning models to use or employ for a domain, thereby improving accuracy and performance.

In embodiments of the system, the machine learning model is pre-trained, and the responses are produced during additional training to fine-tune the machine learning model for a domain. This enables the machine learning model to be analyzed during fine-tuning to be continuously updated (or re-trained) based on the analysis (e.g., indicating datasets, prompts, etc. causing the improper responses or vulnerabilities) to improve model security, reduce failures (or improper responses), and increase times (or amount of inputs) between failures.

In embodiments of the system, the machine learning model includes a large language model. This enables a large language model to be analyzed and updated for mitigating vulnerabilities and improving accuracy and performance.

In embodiments of the system, the input data includes clean data and clean prompts that cause the machine learning model to produce a proper response, and attack data and attack prompts that cause the machine learning model to produce an improper response. This enables a thorough evaluation of the machine learning model based on various datasets to enable updates for mitigating vulnerabilities and improving accuracy and performance.

In embodiments of the system, the responses are produced for a first trial including the clean data and clean prompts and a second trial including the attack data and attack prompts, and determining the probability for the time to an improper response comprises determining the probability for the time to an improper response for the machine learning model based on probabilities for the time to an improper response determined for the first and second trials. This enables the machine learning model to be analyzed against different datasets in separate trials to evaluate the machine learning model for vulnerabilities under different conditions, thereby enabling updating of the machine learning model for mitigating vulnerabilities and improving accuracy and performance.

In embodiments of the system, the processor identifies the input data causing the improper responses, and modifies a training set for the machine learning model to compensate for the identified input data. The processor re-trains the machine learning model with the modified training set to mitigate the improper responses. This enables the machine learning model to be analyzed and continuously updated (or re-trained) based on the analysis (e.g., indicating datasets, prompts, etc. causing the improper responses or vulnerabilities) to improve model security, reduce failures (or improper responses), and increase times (or amount of inputs) between failures. Further, embodiments may identify specific models and/or data causing improper responses and specifically modify training sets and training of the specific models, thereby avoiding training of all models for a domain.

According to an aspect of the invention, a computer program product for detecting and mitigating vulnerabilities in machine learning models comprises one or more computer readable storage media having program instructions collectively stored on the one or more computer readable storage media. The program instructions are executable by a processor to cause the processor to produce, via a machine learning model, responses to input data. The input data includes data that causes the machine learning model to produce proper and improper responses. The program instructions cause the processor to maintain information associated with the input data and responses. The information includes timing information for the responses. The program instructions cause the processor to determine a probability for a time to an improper response for the machine learning model based on the maintained information. The program instructions cause the processor to identify a hazard level for the machine learning model based on the probability for the time to an improper response. This provides security for machine learning models to avoid attacks. In addition, the analysis enables selection of the best (or most secure) machine learning models to use or employ for a domain, thereby improving accuracy and performance.

In embodiments of the computer program product, the machine learning model is configured for a specific domain. This enables use of various machine learning models specific to corresponding domains to improve accuracy and performance.

In embodiments of the computer program product, the machine learning model is pre-trained, and the responses are produced during additional training to fine-tune the machine learning model for the domain. This enables the machine learning model to be analyzed during fine-tuning to be continuously updated (or re-trained) based on the analysis (e.g., indicating datasets, prompts, etc. causing the improper responses or vulnerabilities) to improve model security, reduce failures (or improper responses), and increase times (or amount of inputs) between failures.

In embodiments of the computer program product, the machine learning model includes a large language model. This enables a large language model to be analyzed and updated for mitigating vulnerabilities and improving accuracy and performance.

In embodiments of the computer program product, the input data includes clean data and clean prompts that cause the machine learning model to produce a proper response, and attack data and attack prompts that cause the machine learning model to produce an improper response. This enables a thorough evaluation of the machine learning model based on various datasets to enable updates for mitigating vulnerabilities and improving accuracy and performance.

In embodiments of the computer program product, the responses are produced for a first trial including the clean data and clean prompts and a second trial including the attack data and attack prompts, and determining the probability for the time to an improper response comprises determining the probability for the time to an improper response for the machine learning model based on probabilities for the time to an improper response determined for the first and second trials. This enables the machine learning model to be analyzed against different datasets in separate trials to evaluate the machine learning model for vulnerabilities under different conditions, thereby enabling updating of the machine learning model for mitigating vulnerabilities and improving accuracy and performance.

In embodiments of the computer program product, the program instructions further cause the processor to identify the input data causing the improper responses, and modify a training set for the machine learning model to compensate for the identified input data. The program instructions cause the processor to re-train the machine learning model with the modified training set to mitigate the improper responses. This enables the machine learning model to be analyzed and continuously updated (or re-trained) based on the analysis (e.g., indicating datasets, prompts, etc. causing the improper responses or vulnerabilities) to improve model security, reduce failures (or improper responses), and increase times (or amount of inputs) between failures. Further, embodiments may identify specific models and/or data causing improper responses and specifically modify training sets and training of the specific models, thereby avoiding training of all models for a domain.

By way of example, an organization may develop a new product using foundation models with a focus on language processing. A challenge lies in safeguarding these models from adversarial attacks and ensuring optimal comprehension scores. An embodiment of the present invention may be employed to drastically reduce time and resources needed to identify and mitigate vulnerabilities of the foundation models related to adversarial attacks. Further, the embodiment can identify potential comprehension-related issues early in the development process for the foundation models, thereby maintaining high-quality language processing fidelity in the product.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

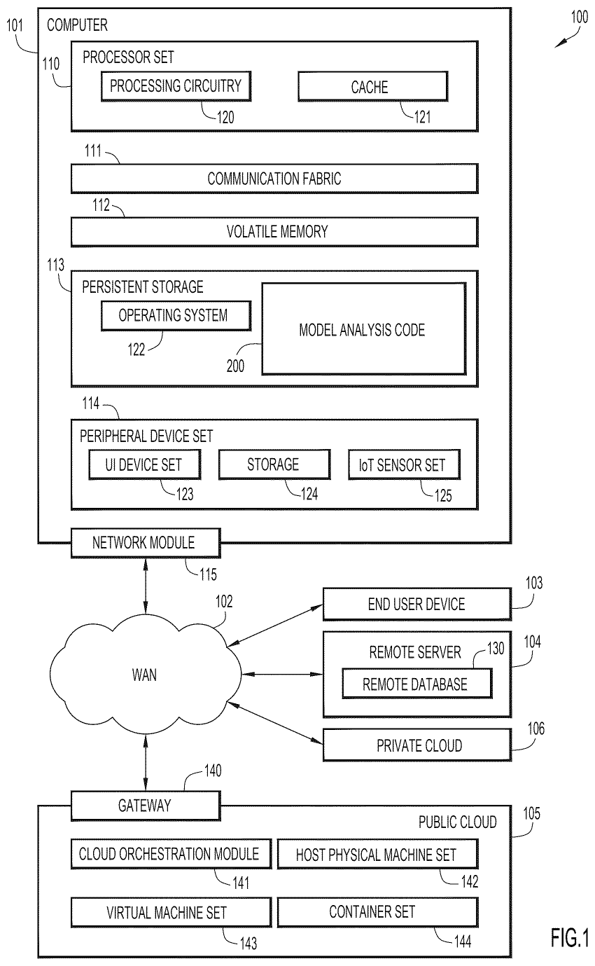

Referring to FIG. 1, computing environment 100 contains an example of an environment for the execution of at least some of the computer code involved in performing the inventive methods, such as model analysis code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer- implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

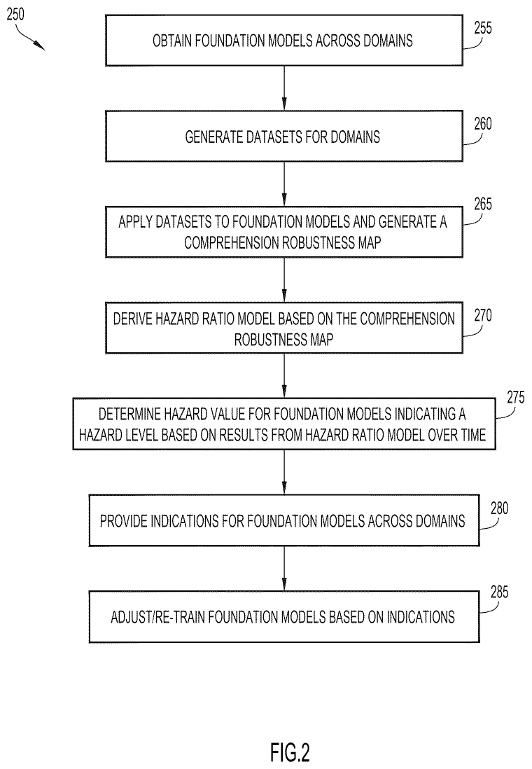

A method 250 to evaluate and update a foundation model (e.g., via model analysis code 200, computer 101, etc.) according to an embodiment of the present invention is illustrated in FIG. 2. Initially, model analysis code 200 receives or obtains a set of foundation models across multiple domains (e.g., Internet of Things (IoT), sensor data, chemistry, digital interactions, programming languages, natural language, speech, etc. which are preferably use case specific) at operation 255. The foundation models may be known to perform better in the domains (e.g., for generative artificial intelligence (AI), etc.).

The foundation models are typically in the form of large-scale machine learning models that are trained on massive datasets of unlabeled data (e.g., Large Language Models (LLM), etc.). These models are capable of learning general representations of the world that can be adapted to a wide range of downstream tasks. The foundation models may employ any conventional or other Large Language Model (LLM) and natural language processing (NLP) techniques to perform tasks. The LLMs may receive a prompt or natural language instruction, and process the prompt to extract and interpret the actions to be performed. The prompt may include several variations and forms. The prompt language to utilize may be obtained by generating various candidate prompts and determining metrics based on the output of the Large Language Model (LLM) relative to desired or known results. The prompts or prompt language achieving greatest accuracy, performance, compliance, and/or other criteria may be used for the prompt provided to an LLM. In this way, prompts may be updated to adjust operation or behavior of the LLMs to improve performance or compliance, or to perform different tasks or behaviors. However, the foundation models may employ any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.). Further, the foundation models may be configured for and/or used with any type of data (e.g., text, image, video, audio, etc.).

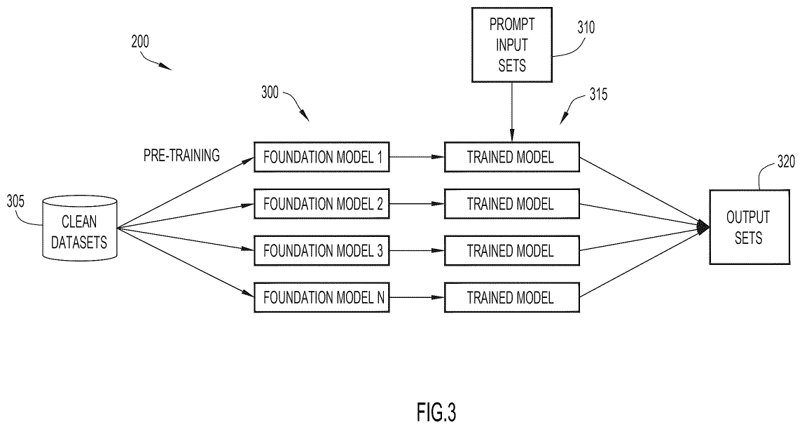

The foundation models are initially pre-trained for a corresponding domain based on a training dataset (e.g., documents, etc.). By way of example and referring to FIG. 3, clean datasets 305 for a domain are used to train foundation models 300 for that domain (e.g., foundation models 1 to N as viewed in FIG. 3) to produce trained foundation models 315. The clean datasets include data that produce proper responses from the foundation models (e.g., cannot be used for any form of attack, etc.). Foundation models 300 process the clean datasets to generate outputs. The outputs are compared to known values, and the difference (or error) between the outputs and known values are used to update foundation models 300. This may be accomplished using any conventional or other machine learning training techniques (e.g., backpropagation, etc.). Trained foundation models 315 process prompt input sets 310 of normal inputs (or prompts) to generate outputs 320.

Clean datasets 305 may be analyzed via any conventional or other techniques (e.g., natural language processing (NLP) techniques, corpus linguistic analysis, etc.) to understand the nature of the pre-trained models. The clean datasets and attributes from the analysis may be included in a comprehension robustness map described below.

Model analysis code 200 curates or generates a number of datasets for corresponding domains at operation 260 (FIG. 2). The datasets include clean datasets, attack datasets, attack input (or prompt) datasets, and clean or normal input (or prompt) datasets. The clean datasets include clean data that produce proper responses from the foundation models (e.g., cannot be used for any form of attack) and may be used to update (e.g., further train and/or fine-tune) the pre-trained foundation models (e.g., provide additional training or training data, data omitted from pre-training, compensate for gaps in the pre-trained foundation models, etc.). Attack datasets include attack data that can be used to expose deficiencies in a foundation model (e.g., generate an improper response, etc.) when creating a fine-tuned model. The attack datasets may be generated by re-arranging and/or modifying data of the clean datasets. Attack input datasets include data (attack inputs or attack prompts) used to obtain improper data (e.g., restricted data, data beyond domain information, etc.) from a foundation model by use on its own or in conjunction with attack or clean datasets. Clean or normal input (or prompt) datasets include data (clean inputs or clean prompts) curated or generated to obtain only domain information from the foundation model.

The clean datasets may be used (alone or in combination with the attack and/or other datasets) to further train and/or fine-tune a pre-trained foundation model for additional aspects (e.g., concepts, comprehension, etc.). By way of example, clean datasets (alone or in combination with the attack and/or other datasets) for a domain are used to provide additional training for and/or fine-tune the pre-trained foundation models for that domain to produce tuned foundation models. The pre-trained foundation models process the datasets to generate outputs. The outputs are compared to known values, and the difference (or error) between the outputs and known values are used to update or fine-tune the foundation models in substantially the same manner described above.

The tuned foundation models may process normal inputs (or prompts) to generate outputs in substantially the same manner described above. The outputs may be used to evaluate the tuned foundation models for the corresponding domain as described below.

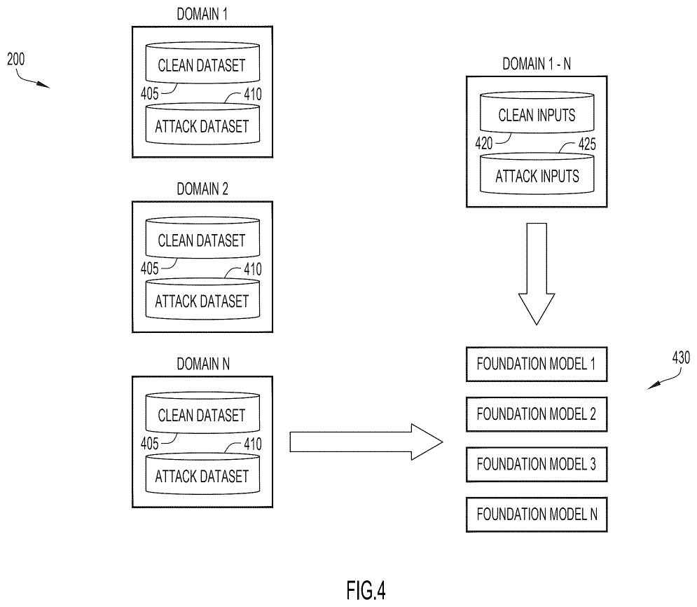

The generated clean datasets, attack datasets, attack input (or prompt) datasets, and clean input (or prompt) datasets may be used to evaluate the foundation models. By way of further example and referring to FIG. 4, model analysis code 200 generates a clean dataset 405, an attack dataset 410, a clean or normal input (or prompt) dataset 420, and an attack input (or prompt) dataset 425 for each domain (e.g., domains 1 to N as viewed in FIG. 4). The data from these datasets 405, 410, 420, 425 are selectively provided to foundation models 430 (in various combinations) to determine the data and/or inputs (or prompts) causing the foundation models to produce an improper response for a corresponding domain as described below. The datasets 405, 410, 420, 425 and responses may be analyzed using any conventional or other techniques to evaluate a cause (e.g., data from datasets 405, 410, 420, and/or 425) of the improper response (e.g., natural language processing (NLP) techniques, corpus linguistic analysis, etc.).

Model analysis code 200 applies the generated datasets to the foundation models and generates a comprehension robustness map at operation 265 (FIG. 2). The foundation models process data from the fine-tuning datasets (e.g., clean and attack datasets) and the prompt datasets (e.g., attack and clean input datasets) to generate outputs. The fine-tuning and prompt datasets contain tags or labels with metadata indicating attributes of the data (e.g., domain, input data, normal or attack prompt, etc.). The output from the foundation models and the dataset metadata information are used to create the comprehension robustness map. This may be accomplished using any conventional or other techniques (e.g., natural language processing (NLP), information extraction/retrieval, etc.). By way of example, the comprehension robustness map may include: an indication of the foundation model used, an indication of the domain, an indication or attributes of data used from the clean dataset, an indication or attributes of data used from the attack dataset, an indication or attributes of data used from the attack input dataset, an indication or attributes of data used from the clean input dataset, the output from the foundation model, the attack type (or data used for the attack) (e.g., fine-tuning data, prompt, fine-tuning data and prompt, etc.), a comprehension value (e.g., based on conventional or other techniques that identify distribution of output data matching domain datasets), and/or an identification of an attack event. The comprehension robustness map may further include data from pre-training of foundation models (e.g., attributes or data from the training dataset, outputs, etc.). The comprehension robustness map may include an entry for each set (or combination of) data processed by a foundation model, and may be implemented by a JavaScript Object Notation (JSON) object or file, a data dictionary, or any other storage unit or structure (e.g., database, file, etc.).

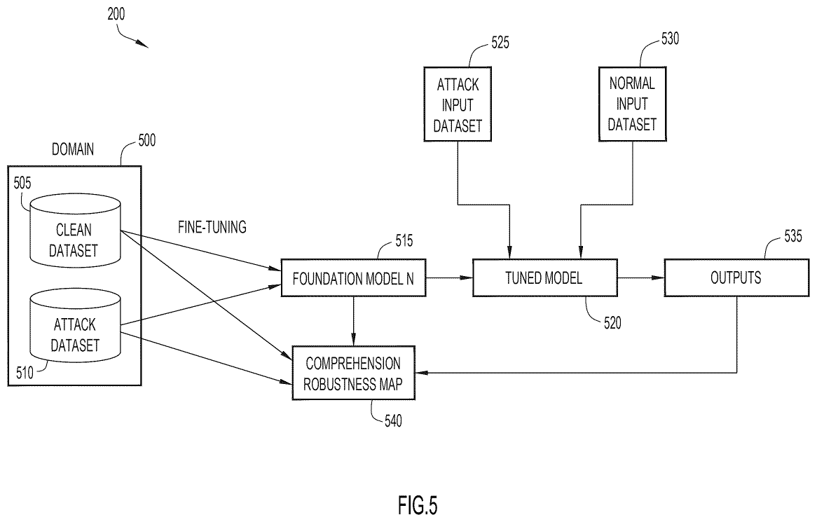

By way of example and referring to FIG. 5, a generated clean dataset 505 and a generated attack dataset 510 for a domain 500 are used to further train or fine-tune a corresponding foundation model 515 for that domain (e.g., foundation model N as viewed in FIG. 5) to produce tuned foundation model 520. The clean dataset includes data that produces a proper response from foundation model 515 (e.g., cannot be used for any form of attack, etc.), while the attack dataset includes data that can be used to expose deficiencies in a foundation model when creating a fine-tuned model as described above. Tuned foundation model 520 processes data from attack input (or prompt) dataset 525 and normal input (or prompt) dataset 530 to produce outputs 535. The attack input dataset includes data (inputs or prompts) used to obtain improper data (e.g., restricted data, data beyond domain information, etc.) from a foundation model, while the normal input (or prompt) dataset includes data (inputs or prompts) used to obtain only domain information from the foundation model as described above. Outputs 535 and metadata from datasets 505, 510, 525, and 530 are analyzed and used to generate a comprehension robustness map 540, preferably having an entry for each combination of data processed by tuned foundation model 520. Any conventional or other techniques may be used to generate the comprehension robustness map (e.g., natural language processing (NLP), information extraction/retrieval, etc.).

In addition, a user may further label attack datasets to improve the generated comprehensive robustness map and further aid in avoiding adversarial attacks.

Model analysis code 200 derives a hazard ratio model based on the generated comprehension robustness map at operation 270 (FIG. 2). The hazard ratio model is derived using the comprehension robustness map and used to calculate hazard ratios that indicate how to mitigate adverse events by changing fine-tuning data (or clean and/or attack datasets) to ensure that the probability of adverse events happening decreases or disappears.

Initially, various combinations of data from datasets (e.g., clean and attack prompts, clean and attack data, etc.) are provided to and processed by the foundation models to produce outputs or responses for evaluation of the foundation models. Timing information for the responses (e.g., the inter-arrival time of (or time between) the responses, etc.) is measured and tracked or maintained to enable analysis over time (or time intervals). The information maintained for the responses may indicate a proper or improper response to provided data (e.g., based on analysis of the responses and provided data via any conventional or other techniques, such as natural language processing (NLP), etc.).

The data for the evaluation may be obtained when generating the comprehension robustness map described above, and/or in a separate operation to evaluate the foundation models. The combinations of data may be selected to form trials, where a first trial may be conducted with clean data and a second trial may be conducted with attack data. However, any number of trials may be conducted with any data. Alternatively, the foundation models may be monitored during (live or test) operation with users, where the timing information (e.g., inter-arrival times, etc.) may be based on API or other calls for user inquiries. The user inquiries and corresponding responses may be analyzed via any conventional or other techniques (e.g., natural language processing (NLP), etc.) to obtain the data for evaluation of the foundation models (e.g., clean/attack inquiries, proper/improper responses, etc.).

The hazard ratio model may determine hazard ratios (or probabilities of times to hazards or improper responses) based on the maintained data in various manners using any conventional or other techniques (e.g., Box-Cox regression, Kaplan-Meier plots and estimation, etc.). The hazard ratio model can be used to analyze conditions for new prompts that use the tuned foundation models. The hazard ratio or probability can be used to indicate whether the data used to train the foundation model along with prompts indicates a potentially degraded state as the time to event (e.g., time to an improper response, etc.) may increase or decrease.

The hazard ratio, HR, is preferably a ratio of trials including a trial with clean data and a trial with attack data. The hazard ratio may be expressed as:

$$HR = ( chance of probability of an event occuring in clean data ) / ( chance or probability of an event occuring in attack data ) .$$

In an embodiment, the hazard ratio model may determine the hazard ratio based on a hazard rate, h(t). The hazard rate is determined as a limit of a ratio of events (e.g., improper responses, etc.) in a time interval to a group size (or input sets) divided by a length of time. The hazard rate indicates the rate for time intervals with a change in time approaching zero, thereby producing an instantaneous hazard rate. The hazard rate may be expressed as follows:

$$h ( t ) = lim ( as Δ t -> 0 ) [ ( \# Events in time interval [ t , t + Δ t ] / N ( t ) ) / Δ t ]$$

where t is time, Δt is a change in time, and N(t) is the number of inputs/prompts at time t. This information may be obtained from the tracked information and the comprehension robustness map. The hazard rate is a probability that an unaffected subject experiences an event between time t and t+Δt, where Δt approaches zero. For example, the hazard rate may be a probability of a foundation model providing an improper response between time t and t+Δt, where Δt approaches zero. The hazard rate may be determined for the trials with clean and attack data and used as the corresponding probabilities in the above expression to produce the hazard ratio. The hazard ratio indicates the probability of a time to an event (e.g., improper response, etc.) for a foundation model for a corresponding time interval.

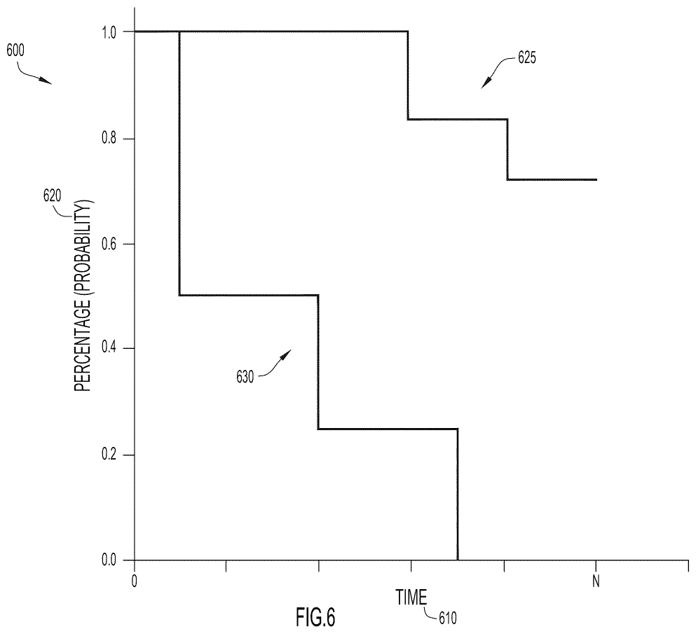

In an embodiment, the hazard ratio model may compare the trials based on the hazard ratio and a P value. By way of example, the hazard ratio and P value may be derived based on curves in a Kaplan-Meier plot. An example Kaplan-Maier plot 600 is illustrated in FIG. 6. An X-axis 610 of the Kaplan-Meier plot may represent time, and a Y-axis 620 of the Kaplan-Meier plot may represent a percentage (or probability) of negative outcomes (or improper responses) of attacks on a foundation model. A curve 625 represents responses for clean data, while a curve 630 represents responses for attack data. The lengths of horizontal segments along X-axis 610 represent a survival duration (or proper responses) for that time interval, where the time interval terminates by occurrence of an event (improper response). The distances between the horizontal segments indicate a change in cumulative probability. The percentage or probability for a time interval may be expressed as the quantity of proper responses divided by the quantity of inputs. The cumulative probability (e.g., represented by Y-axis 620) for a time interval (represented by X-axis 610) may be determined by multiplying the interval probabilities for the prior intervals.

The hazard ratio is a measure of a magnitude of a difference between curves 625, 630 in Kaplan-Meier plot 600, while the P value measures a statistical significance of this difference. The statistical significance may be determined via any conventional or other statistical techniques (e.g., log rank test, calculating a chi-square for each time of an event and adding the results, etc.).

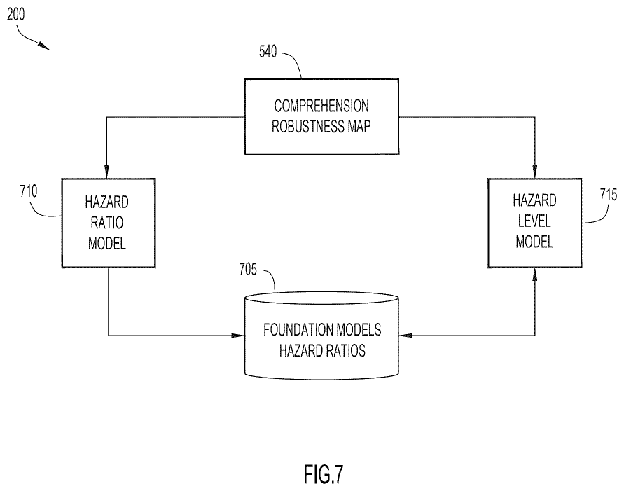

By way of example and referring to FIG. 7, comprehension robustness map 540 is generated based on foundation models processing fine-tuning and prompt datasets in substantially the same manner described above. Trials are conducted for foundation models based on clean and attack datasets, and hazard ratios 705 for the foundation models are determined by hazard ratio model 710 in substantially the same manner described above. The comprehension robustness map and hazard ratios are provided to a hazard level model 715 for analyzing responses and the datasets and indicating a level or degree of hazard for the foundation models. For example, the hazard level model may indicate that a foundation model has a low probability of a hazard, a decreasing probability of a hazard (e.g., indicating alteration of datasets and/or prompts for the foundation model), or a high or increasing probability of a hazard (e.g., indicating alteration of datasets and/or prompts for the foundation model). The datasets are tracked (e.g., by the comprehension robustness map, etc.) as described above to enable identification of the data causing the improper response. In this case, the datasets may be altered to modify, remove, or otherwise compensate for the data causing the improper response.

Model analysis code 200 determines a hazard value (via the hazard level model) to indicate which foundation models provide minimal, or a lowest amount of, hazards (e.g., improper responses, etc.) in a particular domain at operation 275 (FIG. 2). The hazard value is derived from the outputs (or hazard ratios) over time of the hazard ratio model. For example, the hazard ratios for a foundation model may be combined by the hazard level model via any conventional or other techniques to produce the hazard value (e.g., mean, median, weighted sum or average, standard deviation, etc.). The hazard value may represent the probability of a time to an improper response for the foundation model over time (based on the probabilities for the time intervals). Model analysis code 200 may produce various items from the analysis including fine-tuned foundation models generated through the combination of the foundation models and clean datasets, comprehension robustness maps that detail model information and corresponding hazard ratios, time-to-event probabilities (e.g., hazard ratios, hazard values, etc.) calculated by the hazard ratio and hazard level models indicating a potential occurrence of an adverse output (over time intervals or time), and categorization or classification of foundation models by hazard levels (e.g., indicating safer models to use for each specific domain, etc.). The foundation models are classified into hazard categories or classes based on the hazard value for the foundation models from the hazard level model.

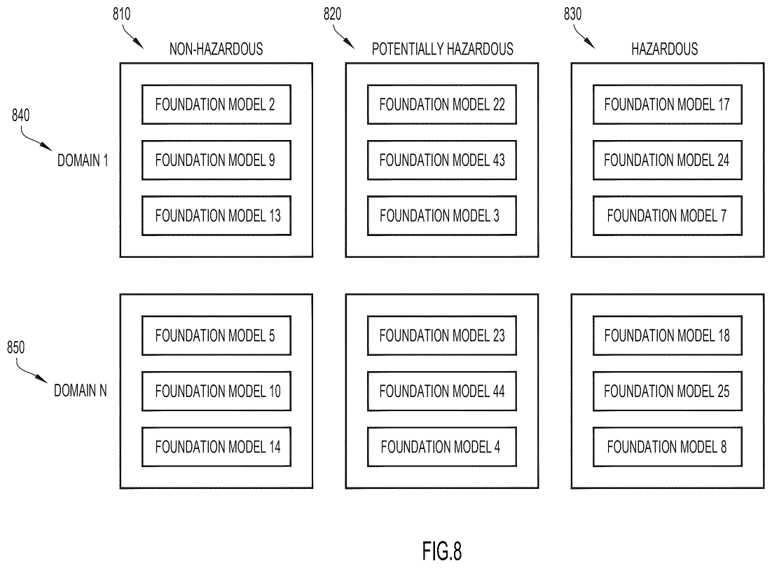

Model analysis code 200 may present (e.g., on a display of a user device, etc.) or otherwise provide hazard indications (e.g., labels, tags, etc.) for the foundation models at operation 280. By way of example and referring to FIG. 8, foundation models of domains 840 (e.g., Domain 1 as viewed in FIGS. 8) and 850 (e.g., Domain N as viewed in FIG. 8) are classified into hazard categories or classes based on the hazard value for the foundation models from the hazard level model. For example, each category may be associated with a threshold which is compared to the hazard value for a foundation model to determine the category or class. The hazard categories include a non-hazardous category 810, a potentially hazardous category 820, and a hazardous category 830.

Non-hazardous category 810 indicates foundation models that provide a low or no probability of a hazard, while potentially hazardous category 820 indicates foundation models that have a moderate or decreasing probability for a hazard (which may cause alteration of associated datasets). Hazardous category 830 indicates foundation models with a high or increasing probability for a hazard (which may cause alteration of datasets).

The results of the evaluation may classify foundation models in the corresponding categories for each domain. By way of example, foundation models 2, 9, and 13 of domain 840 are indicated as non-hazardous, foundation models 3, 22, and 43 of domain 840 are indicated as potentially hazardous, and foundation models 7, 17, and 24 of domain 840 are indicated as hazardous. Further, foundation models 5, 10, and 14 of domain 850 are indicated as non-hazardous, foundation models 4, 23, and 44 of domain 850 are indicated as potentially hazardous, and foundation models 8, 18, and 25 of domain 850 are indicated as hazardous. Model analysis code 200 may select foundation models to use based on the hazard levels (e.g., preference to non-hazardous models, etc.).

Machine analysis code 200 adjusts (or re-trains) the foundation models based on the indications or classifications at operation 285 (FIG. 2). For example, the datasets and/or prompts for potentially hazardous and hazardous foundation models may be altered and used to update (or re-train) the models to avoid attacks. The datasets and/or prompts may be altered to modify, remove, or otherwise compensate for the data causing the improper response.

Present invention embodiments may provide several technical and other advantages. For example, present invention embodiments may provide security for foundation models to avoid attacks. The foundation models may be analyzed and continuously updated (or re-trained) based on the analysis (e.g., indicating datasets, prompts, etc. causing the improper responses or vulnerabilities) to improve model security, reduce failures (or improper responses), and increase times (or amount of inputs) between failures. Further, the present invention embodiments may identify specific models and/or data causing improper responses and specifically modify training sets and training of the specific models, thereby avoiding training of all models for a domain. In addition, the analysis enables selection of the best (or most secure) foundation models to use or employ for a domain, thereby improving accuracy and performance.

It will be appreciated that the embodiments described above and illustrated in the drawings represent only a few of the many ways of implementing embodiments for detection and mitigation of hazards in machine learning foundation models.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., model analysis code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., foundation models, analysis results, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., analysis results, etc.).

The present invention embodiments are not limited to the specific tasks or algorithms described above, but may be utilized for analyzing vulnerabilities of any machine learning models and using the identified vulnerabilities to modify the models to mitigate the vulnerabilities.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of detecting and mitigating vulnerabilities in machine learning models comprising:
producing, via a machine learning model of a processor, responses to input data, wherein the input data includes data that causes the machine learning model to produce proper and improper responses;
maintaining, via the processor, information associated with the input data and responses, wherein the information includes timing information for the responses;
determining, via the processor, a probability for a time to an improper response for the machine learning model based on the maintained information; and
identifying, via the processor, a hazard level for the machine learning model based on the probability for the time to an improper response.

2. The method of claim 1, wherein the machine learning model is configured for a specific domain.

3. The method of claim 2, wherein the machine learning model is pre-trained, and the responses are produced during additional training to fine-tune the machine learning model for the domain.

4. The method of claim 1, wherein the machine learning model includes a large language model.

5. The method of claim 4, wherein the input data includes clean data and clean prompts that cause the machine learning model to produce a proper response, and attack data and attack prompts that cause the machine learning model to produce an improper response.

6. The method of claim 5, wherein the responses are produced for a first trial including the clean data and clean prompts and a second trial including the attack data and attack prompts, and wherein determining the probability for the time to an improper response comprises:
determining the probability for the time to an improper response for the machine learning model based on probabilities for the time to an improper response determined for the first and second trials.

7. The method of claim 1, further comprising:
identifying, via the processor, the input data causing the improper responses;
modifying, via the processor, a training set for the machine learning model to compensate for the identified input data; and
re-training, via the processor, the machine learning model with the modified training set to mitigate the improper responses.

8. A system for detecting and mitigating vulnerabilities in machine learning models comprising:
one or more memories; and
a processor coupled to the one or more memories and configured to:
produce, via a machine learning model, responses to input data, wherein the input data includes data that causes the machine learning model to produce proper and improper responses;
maintain information associated with the input data and responses, wherein the information includes timing information for the responses;
determine a probability for a time to an improper response for the machine learning model based on the maintained information; and
identify a hazard level for the machine learning model based on the probability for the time to an improper response.

9. The system of claim 8, wherein the machine learning model is pre-trained, and the responses are produced during additional training to fine-tune the machine learning model for a domain.

10. The system of claim 8, wherein the machine learning model includes a large language model.

11. The system of claim 10, wherein the input data includes clean data and clean prompts that cause the machine learning model to produce a proper response, and attack data and attack prompts that cause the machine learning model to produce an improper response.

12. The system of claim 11, wherein the responses are produced for a first trial including the clean data and clean prompts and a second trial including the attack data and attack prompts, and wherein determining the probability for the time to an improper response comprises:
determining the probability for the time to an improper response for the machine learning model based on probabilities for the time to an improper response determined for the first and second trials.

13. The system of claim 8, wherein the processor is further configured to:
identify the input data causing the improper responses;
modify a training set for the machine learning model to compensate for the identified input data; and
re-train the machine learning model with the modified training set to mitigate the improper responses.

14. A computer program product for detecting and mitigating vulnerabilities in machine learning models, the computer program product comprising one or more computer readable storage media having program instructions collectively stored on the one or more computer readable storage media, the program instructions executable by a processor to cause the processor to:
produce, via a machine learning model, responses to input data, wherein the input data includes data that causes the machine learning model to produce proper and improper responses;
maintain information associated with the input data and responses, wherein the information includes timing information for the responses;
determine a probability for a time to an improper response for the machine learning model based on the maintained information; and
identify a hazard level for the machine learning model based on the probability for the time to an improper response.

15. The computer program product of claim 14, wherein the machine learning model is configured for a specific domain.

16. The computer program product of claim 15, wherein the machine learning model is pre-trained, and the responses are produced during additional training to fine-tune the machine learning model for the domain.

17. The computer program product of claim 14, wherein the machine learning model includes a large language model.

18. The computer program product of claim 17, wherein the input data includes clean data and clean prompts that cause the machine learning model to produce a proper response, and attack data and attack prompts that cause the machine learning model to produce an improper response.

19. The computer program product of claim 18, wherein the responses are produced for a first trial including the clean data and clean prompts and a second trial including the attack data and attack prompts, and wherein determining the probability for the time to an improper response comprises:
determining the probability for the time to an improper response for the machine learning model based on probabilities for the time to an improper response determined for the first and second trials.

20. The computer program product of claim 14, wherein the program instructions further cause the processor to:
identify the input data causing the improper responses;
modify a training set for the machine learning model to compensate for the identified input data; and
re-train the machine learning model with the modified training set to mitigate the improper responses.
